(19) United States
(12) Patent Application Publication
(10) Pub. No.: US 2007/0125821 A1
(43) Pub. Date: Jun. 7, 2007

(54) Structure of arresting mechanism for nail guns

(75) Inventor: Guan-Ho Wang, Tali City (TW)

Correspondence Address: CHARLES E. BAXLEY, ESQ., 90 JOHN STREET, THIRD FLOOR, NEW YORK, NY, 10038, US

(73) Assignee: Nailermate Enterprise Corp.

(21) Appl. No.: 11/293,325

(22) Filed: Dec. 2, 2005

(51) Int. Cl. B25C 1/04

(52) U.S. Cl. 227/8; 227/130

(57) ABSTRACT

A structure of an arresting mechanism for a nail gun, wherein the nail gun is composed of a nailing device. The nail gun further comprises a trigger, which is fastened between two pin plates of the nailing device and can be cocked to shoot nails. The arresting mechanism contains a reciprocating cotter pierced through the two pin plates; at lease one retaining part disposed on the trigger; a swinging sensing component, which is fastened together with the magazine, with its first end in the location corresponding to the magazine and further extending into the magazine to reach the nail and the second end reaching the head of the cotter. Accordingly to foregoing structure, when there is no nail loaded in the magazine, the trigger cannot be cocked by the users; contrarily, when nails are loaded in the magazine, the trigger can be cocked.

### FIELD OF THE INVENTION

The present invention relates to a nail gun, more particularly to a structure of arresting mechanism for nail guns for preventing users from shooting the nail gun without nails.

### BACKGROUND OF THE INVENTION

Generally speaking, a prior-art nail gun is composed by a magazine and a nailing device. The magazine accommodates nails and the nailing device provides a trigger for the users to cock and shoot the nails. When there are nails loaded in the nail gun, the nailing device typically shoots at least one nail every time the users cock the trigger. However, when there is no nail in the magazine, the users can still cock the trigger and the nailing device reacts to the users' cocking as normal but no nail be shot. Moreover, the users would usually cock several more times to make sure there is no nail in the magazine and that would harm the nailing device. It is expectable that the life of the nail guns would be shorten if such an ineffective shooting is taken frequently.

### SUMMARY OF THE INVENTION

The primary objective of the present invention is to provide a solution to the problem that the trigger of a prior-art nail gun can be cocked without nails and causes the nailing device to act ineffectively. The purpose and effect of the present invention is to provide a mechanism that restrains the cocking when there is no nail in the magazine.

The technical measures taken by the invention to achieve foregoing purpose and effect are given below:

A structure of arresting mechanism is applied to a nail gun that is composed by a magazine and a nailing device. The nail gun further comprises a trigger, which is fastened between two pin plates of the nailing device and can be cocked to shoot. The arresting mechanism contains a cotter, which is threaded through the two pin plates and has a head that appears on the pin plate; at least one salient axis part and at least one concave axis part disposed on said cotter, wherein the shaft diameter of the concave axis part is smaller than it of the salient axis part; a spring, with its one end stretching to said pin plate, which houses the cotter and its elastic force affects thereupon; at lease one retaining part disposed on the trigger that allows the salient axis part of the cotter being arrested and retained thereon; a swinging sensing component, which is fastened together with the magazine, with its first end in the location corresponding to the magazine and further extending into the magazine to reach the nail and the second end reaching the head of said cotter.

### BRIEF DESCRIPTION OF THE DRAWINGS

FIG. 1 is an exploded view of the arresting mechanism of the present invention.

FIG. 2 is a view showing the arresting mechanism of the present invention applied to a nail gun.

FIG. 3 is a sectional view taken along line 3-3 of FIG. 2 and showing nails in the magazine.

FIG. 4 is according to FIG. 3 and showing no nail in the magazine.

FIG. 5 is a sectional view taken along line 5-5 of FIG. 3.

FIG. 6 is a sectional view taken along line 6-6 of FIG. 4.

### DETAILED DESCRIPTION OF THE PREFERRED EMBODIMENT

To make it easier for our examiner to understand the objective of the invention, its structure, innovative features, and performance, we use a preferred embodiment together with the attached drawings for the detailed description of the invention.

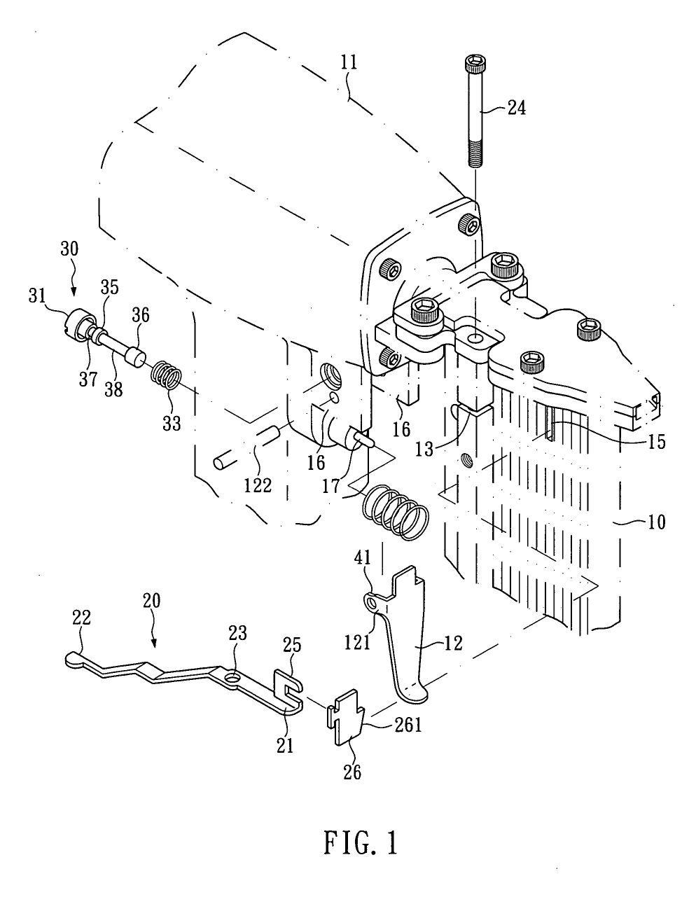

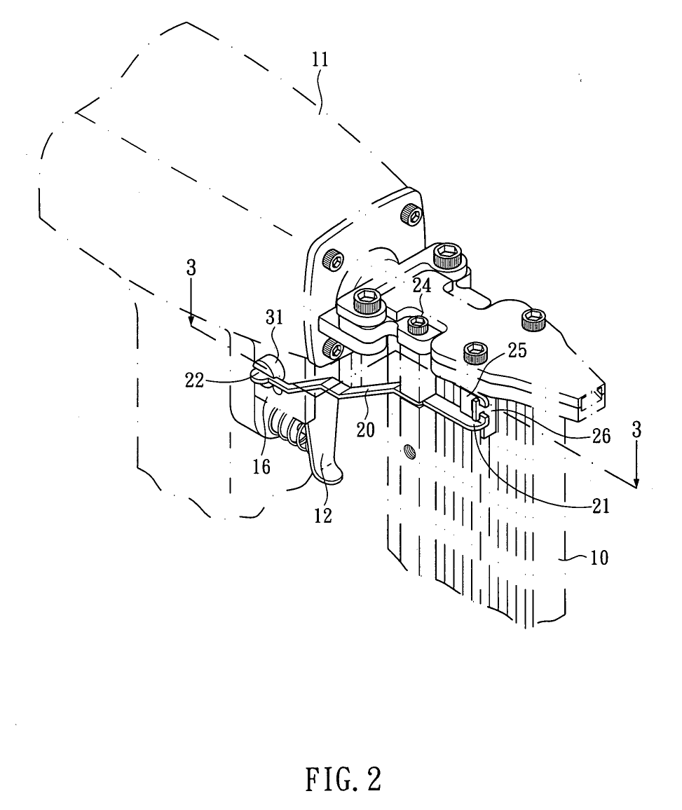

Please refer to FIGS. 1, 2 and 3 for a nail gun according to the present invention, which comprises a magazine 10 and a nailing device 11. The magazine 10 accommodates nails and the nailing device 11 provides a trigger 12 for the users to cock and shoot the nails. The trigger 12 compresses an actuator 17 when being cocked. Generally, the actuator 17 makes the nailing device 11 to shoot at least one nail each time the users cock the trigger. The invention is to provide an arresting mechanism against shooting without nails for any type of nail guns. The mechanism comprises:

a sensing component 20 which can be combined outside the magazine 10. The first end 21 of the sensing component is extended into the magazine 10 to reach the nails and the second end 22 is extended toward the side of the trigger 12. As shown in the figures, a space 13 is disposed outside the magazine 10 for accommodating the sensing component 20. The sensing component 20 further comprises an axial hole 23 which is disposed corresponding to the space 13. A fixing component 24 positions the sensing component 20 by threading through the space 13 and axial hole 23 and allows the sensing component 20 pivoting horizontally on the fixing component 24 like a seesaw. A fastening device 25 is disposed at the first end 21 of the sensing component 20 to combine a tenon 26 which is extended into the magazine 10 via a through hole 15. The tenon 26 provides a inclined plane 261 inside the magazine 10 and when passing by the inclined plane 261, the nails push the tenon 26 outward the magazine 10. Therefore, the first end 21 of the sensing component 20 acts correspondingly and the second end 22 of the sensing component 20 goes contrary.

A cotter 30 which is threaded through the pin plates 16 of the nailing device 11 has a head 31 appears on the pin plate 16. A socket 32 is arranged on the top of the head 31 to contain and hold the second end 22 of the sensing component 20. A spring 33 is disposed between the head 31 and the pin plate 16 to coact with the cotter 30; the cotter 30 compresses the spring 33 when being pushed by the second end 22 of the sensing component 20 and when the pressing force disappears, the spring 33 is resilient and pushes the cotter 30 reposited. The cotter 30 located between the pin plates 16 further comprises at least one salient axis part 35 and at least one concave axis part 37 which are arranged coaxially. Further, the shaft diameter of the concave axis part 37 is smaller than it of the salient axis part 35. Please refer to the figures again; according to the present invention, a first and second salient axis parts 35, 36 are disposed on a cotter 30. A first concave axis part 37 is disposed between the first salient axis part 35 and head 31 and a second concave axis part 38 is disposed between the second salient axis part 36 and the first salient axis part 35.

There is at least one pair of retaining parts 41, 42 disposed on said trigger 12 to allow the first and second salient axis parts 35,36 of the cotter 30 arrested and retained thereon so that the trigger 12 is wedged and can not be cocked by the users. As shown in the figures, there are wing sections 121 equipped at each side of said trigger 12 to allow a pin 122 threading through for fastening the trigger 12 between the two pin plates 16. The foregoing retaining parts 41, 42 are respectively disposed on the top surfaces of the wing sections 121 and are presented in the form of sockets.

Accompanied with the description of the foregoing structure, the principle of the movements for this invention is elaborated as follows:

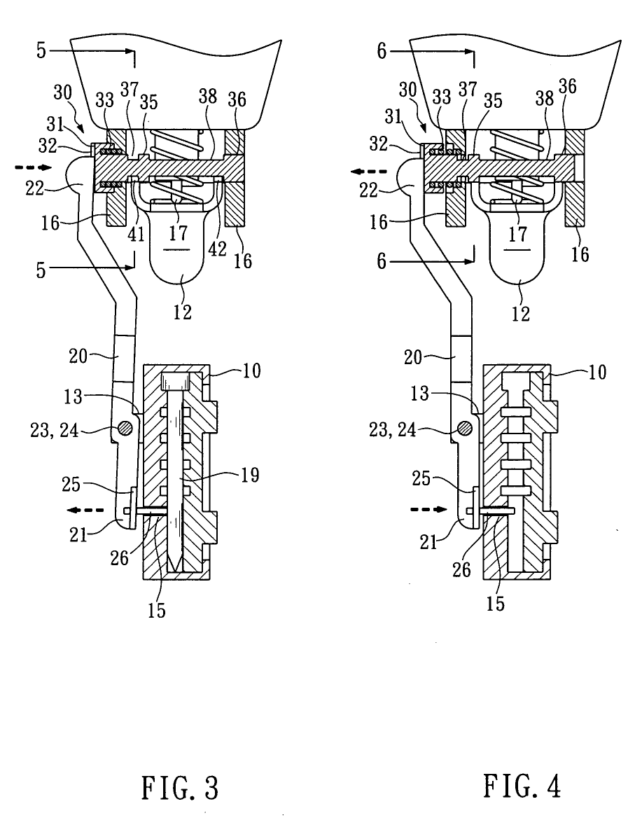

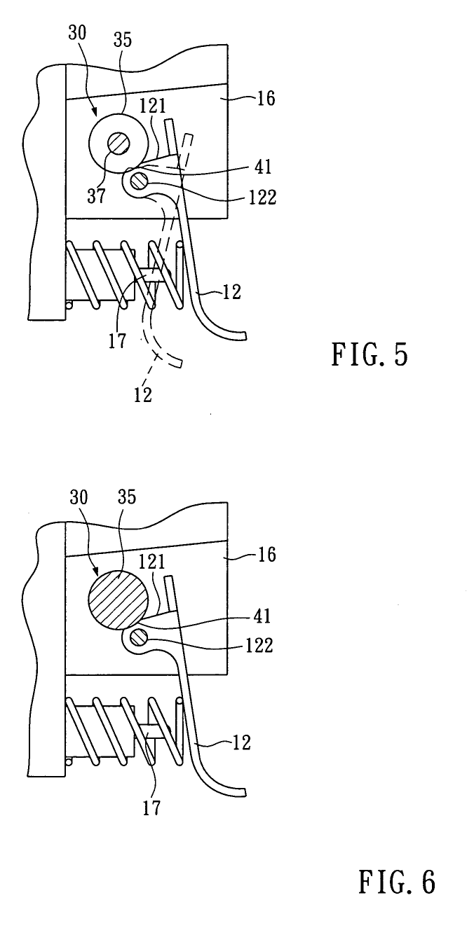

Please referring to FIGS. 3 and 5 for the invention. If there are some nails 19 loaded in the magazine 10, the nails shore up the tenon 26 outward the magazine 10, and accordingly, the first end 21 of the sensing component 20 acts correspondingly and the second end 22 of the sensing component 20 goes contrary to push the head 31 of the cotter 30. When the cotter 30 sequentially compresses the spring 33, the first and second concave axis part 37, 38 is located correspondingly to the retaining parts 41, 42 of the trigger 12. Since the shaft diameter of first and second concave axis parts 37, 38 is too small to be arrested by the retaining parts 41, 42, the trigger 12 can be cocked (as the dotted line shown in FIG. 5) and the nail gun is allowed shooting.

In FIGS. 4 and 6, when there is no nail 19 loaded in the magazine 10, that is to say, the force shoring up the tenon 26 outward the magazine 10 no more exists. Thus, there is no propulsive force from the second end 22 of the sensing component 20 to the head 31 of the cotter 30. The spring 33 of the cotter 30 gets released and brings the first and second salient axis parts 35,36 arrested and retained by the retaining parts 41, 42 of the trigger 12. Then the trigger 12 cannot be cocked.

In summation of the above description, the present invention enhances the performance of the conventional structure, and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A structure of arresting mechanism for a nail gun, wherein the nail gun comprises: a magazine, a nailing device and a trigger fastened between two pin plates of the nailing device, the structure of the arresting mechanism compreses:
a cotter, with the cotter piercing through the two pin plates of the nailing device and having a head appearing on one of the pin plates
a spring, which is urrounding the cotter and has one end thereof distant from the head pressing upon said pin plate whereby an elastic force thereof acts on the cotter;
at least one retaining part disposed on said trigger which allows the salient convex axis parts part of the cotter being arrested and retained thereon;
a sensing component, which is seingably fastened to the magazine whereby a first end thereof is settled about the magazine and extended into the magazine for contacting the nails while a second end thereof comes into contact with the head of said cotter.

2. The structure of arresting mechanism of claim 1, wherein, a fixing component passes through a space, which is disposed outside of said magazine for accommodating the sensing component and an axial hole, which is disposed corresponding to the space to fasten the sensing component to the magazine whereby the sensing component can swing on the fixing component and has the first and second ends thereof swinging like a seesaw.

3. The structure of arresting mechanism of claim 1, wherein, a through hole is disposed on the magazine to allow the first end of the sensing component extending into the magazine and contact the nails.

4. The structure of arresting mechanism of claim 1, wherein, a tenon is disposed at the first end of the sensing component and extending into the magazine via said through hole of the magazine.

5. The structure of arresting mechanism of claim 1, wherein, a socket is disposed on the head of said cotter for containing the second end of the sensing component.

6. The structure of arresting mechanism of claim 1, wherein the spring is disposed between one of the pin plates and the head of said cotter.

7. The structure of arresting mechanism of claim 1, wherein, two wing sections are equipped at each side of said trigger to receive a pin piercing therethrough to moveably fix the trigger between the two pin plates and the retaining part is disposed on the top surfaces of at least one of the wing sections.

8. The structure of arresting mechanism of claim 1, wherein, the retaining part is a socket for receiving the convex axis part of said cotter.

9. The structure of arresting mechanism of claim 1, wherein, a first convex axis part and a second convex axis part are disposed on the cotter while a first concave axis part is disposed between the first convex axis part and said head and a second concave axis part is disposed between the second convex axis part and the first convex axis part.
